(19) United States
(12) Patent Application Publication
(10) Pub. No.: US 2024/0109418 A1
(43) Pub. Date: Apr. 4, 2024

(54) METHOD FOR OPERATING AN OPERATING DEVICE FOR A MOTOR VEHICLE, AND MOTOR VEHICLE HAVING AN OPERATING DEVICE

(71) Applicant: Volkswagen Aktiengesellschaft, Wolfsburg (DE)

(72) Inventors: Henning Thiele, Wolfsburg (DE); Wojciech Huwer, Braunschweig (DE); Anette Grüneberg, Hannover (DE); Spiro Trikaliotis, Oebisfelde-Weferlingen (DE); Olga Helwich, Leiferde (DE); Maximilian Barthel, Markkleeberg (DE); Sema Altug, Braunschweig (DE); Hyein Shin, Berlin (DE); Stephanie Albrecht, Wolfsburg (DE); Volkmar Wagner, Berlin (DE)

(21) Appl. No.: 18/263,693

(22) PCT Filed: Jan. 18, 2022
(86) PCT No.: PCT/EP2022/050997

§ 371 Date: Jul. 31, 2023

(30) Foreign Application Priority Data
Feb. 9, 2021 (DE) 10 2021 201 184.5

(51) Int. Cl. B60K 35/10; B60K 35/21; B60K 35/234; B60K 35/28; B60K 35/81; G06F 3/0362; G06F 3/0482; G06F 3/04847; G06F 3/0488

(52) U.S. Cl. CPC B60K 35/10; B60K 35/212; B60K 35/234; B60K 35/28; B60K 35/81; G06F 3/0362; G06F 3/0482; G06F 3/04847; G06F 3/0488; B60K 2360/126; B60K 2360/1438; B60K 2360/164; B60K 2360/172; B60K 2360/345

(57) ABSTRACT

Technologies and techniques for operating an operating device for a motor vehicle, in which a first touchscreen user input is received, characterizing a selection of a selection level, wherein a first selection level provides different adjustable driving modes as list participants, and a second selection level provides different adjustable ambience modes as list participants, one arranged by turning a ring element which circumferentially encloses the screen device, a second user input represented about an axis of rotation is received, which characterizes a selection of a list participant from a plurality of list participants in the chosen selection level. Depending on the first user input and/or the second user input, a control signal is provided characterizing a driving mode to be set and/or an ambience mode to be set in which a display of the driving mode and/or the ambience mode is triggered using the screen device.

### RELATED APPLICATIONS

The present application claims priority to International Patent Application No. PCT/EP2022/050941 to Thiele, et al., titled “Operating Method For An Operating Device For A Motor Vehicle And A Motor Vehicle With An Operating Device”, filed Jan. 18, 2022, which claims priority to German Patent App. No. DE 10 2021 201 185.3, filed Feb. 9, 2021, the contents of each being incorporated by reference in their entirety herein.

### FIELD OF TECHNOLOGY

The present disclosure relates to a method for operating an operating device for a motor vehicle and a motor vehicle with an operating device.

### BACKGROUND

A multifunction rotary control device for controlling a system is already known from GB 2494420 A1, which provides control signals for the system which are delivered according to the actuation of a manually operable rotary actuator and a switch. Information about a variety of operating modes for the system can be displayed via a display on the multifunction rotary control device. The display presents the information to a user on a circular area of the multifunction rotary controller, which is centered on an axis of rotation of the rotary actuator. The rotary actuator can be a knob, in particular, circular, can be gripped by a user's hand, and can comprise a lever. The switch can be a mechanical switch actuated by pressing the button, the display, or a window through which the display is visible. The display can comprise a touch-sensitive surface which is fixed in its orientation, whereas the rotary actuator can be rotated about the axis of rotation. A plurality of user input modes and control functions can be selected and controlled by operating the rotary actuator and the switch in combination. The multifunction rotary control device can be used to control a system such as an air conditioner, including functions such as ventilation, air temperature, and seat heating/cooling temperature in a motor vehicle.

### SUMMARY

Aspects the present disclosure are to provide solutions that makes it possible to control a particularly large number of motor vehicle functions with fewer user inputs, using fewer operating elements.

Some aspects are achieved by a method for operating an operating device for a motor vehicle and by a motor vehicle having an operating device with the features of the independent patent claims. Further possible configurations of the present disclosure are disclosed in the dependent claims, the description, and the figures.

In some examples, a method is disclosed for operating an operating device for a motor vehicle, in which a first user input, represented by touching the touch-sensitive surface of a screen device, is received. This first user input characterizes a choice of a selection level from a plurality of selection levels. In this case, the screen device can display the respective selection levels that are available for selection. A person can thus choose the selection level from the plurality of selection levels through the first user input via the touch-sensitive surface. A first selection level can provide different adjustable driving modes as list participants and a second selection level can provide different adjustable ambience modes as list participants. This means that the person can specify via the first user input whether the selection level of the driving modes or the selection level of the ambience modes is to be chosen as the selection level. By touching the touch-sensitive surface, the user can switch between the respective selection levels available for selection.

In some examples, a motor vehicle is disclosed with an operating device that is configured to be operated using the methods disclosed herein. The motor vehicle may be configured, for example, as a passenger car. The operating device can, for example, have the screen device with touch-sensitive surface, ring element, and control device. Furthermore, the operating device can have the base element, which is configured for attachment to an interior component of the motor vehicle. The motor vehicle equipped with the operating device enables persons or vehicle occupants to control a particularly large number of different participants in the motor vehicle simultaneously via a particularly small number of operating elements by means of a particularly small number of user inputs. Advantages and further embodiments of the method according to the present disclosure are to be regarded as advantages and further embodiments of the motor vehicle according to the present disclosure.

### BRIEF DESCRIPTION OF THE DRAWINGS

Further features of the invention can result from the following description of the figures and from the drawing. The features and feature combinations named above in the description and the features and feature combinations shown below in the description of the figures and/or in the figures alone can be used not only in the combination specified in each case, but also in other combinations or on their own, without going beyond the scope of the invention.

The drawings show:

FIG. 1a-1b illustrate respective schematic perspective views of an operating device for a motor vehicle, by means of which a driving mode can be selected from several predetermined driving modes or by means of which an ambience mode can be selected from several predetermined ambience modes, wherein FIG. 1a depicts a first user input on the operating device and FIG. 1b depicts a second user input on the operating device, according so some aspects of the present disclosure;

FIG. 2 illustrates a plurality of schematic perspective views of the operating device, wherein the operating device is shown with a display characterizing a set or a selected driving mode, with a display characterizing a selected or a set ambience mode, with a display providing a plurality of list participants of a predetermined driving mode, and with a display providing a plurality of list participants of a predetermined ambience mode, according so some aspects of the present disclosure; and

FIG. 3 illustrates a method schematic for adjusting the operating device from a passive mode, in which the operating device displays a set or selected ambience mode and/or driving mode, into a standby mode, in which the operating device can detect the first user input and the second user input, according so some aspects of the present disclosure.

### DETAILED DESCRIPTION

Elements that are the same or have the same function are provided with the same reference symbols in the figures.

In some examples disclosed herein, a first user input may characterize a choice of a selection level from a plurality of selection levels. In some examples, a second user input may be received, representing an axis of rotation by rotating a ring element, which is arranged circumferentially enclosing the screen device. This second user input may be configured to characterize a selection of a list participant from a plurality of list participants in the chosen selection level. In particular, the ring element can be arranged in different rotation positions about the axis of rotation. In particular, each of the rotation positions of the ring element can be assigned a respective list position of a respective selection level. By arranging the ring element in the respective rotation position, the list participant of the chosen selection level located at the list position characterized by the rotation position can be selected via the second user input. The operating device thus includes the screen device with the touch-sensitive surface, via which the first user input can be received, and the ring element, which can be arranged about the axis of rotation in different rotation positions around the screen device and by means of which the second user input can be received. The screen device can thus be used to choose via the first user input within which selection level a list participant is to be selected. By using the ring element, a list participant to be chosen may be chosen from the plurality of list participants of the chosen selection level via the second user input by rotating the ring element about the axis of rotation. It is thus possible to switch between the different selection levels by touching the screen device, whereas it is possible to switch between the respective list participants within a selection level by rotating the ring element about the axis of rotation.

In some examples, a control device of the operating device, depending on the first user input and/or the second user input, provides a control signal that characterizes a driving mode and/or ambience mode to be set for the motor vehicle. Furthermore, the control device triggers a display of the driving mode and/or the ambience mode by means of the screen device. The control device can thus be used to provide the control signal, in particular for an electronic computing device in the motor vehicle, which characterizes which list participant has been chosen from which selection level via the first user input and the second user input for setting in the motor vehicle. Here, the first user input can characterize whether a driving mode or an ambience mode has been selected. The second user input can characterize which driving mode has been selected from the plurality of driving modes or which ambience mode has been selected from the multiple ambience modes. This selected ambience mode or driving mode is represented by the control signal. The control device can thus use the control signal provided to inform the electronic computing device about the selected driving mode or the selected ambience mode. As a result, the electronic computing device in the motor vehicle can set the selected driving mode or the selected ambience mode. The setting of the selected ambience mode or the setting of the selected driving mode in the motor vehicle can thus be triggered by the provision of the control signal by the control device.

So that a person can be particularly easily informed about the list participant that has been set or selected, such as the set and/or selected driving mode or the set and/or selected ambience mode, the method envisages that the control device controls the screen device in such a way that the screen device displays the set list participant or the selected list participant and thus the set and/or selected driving mode or the set and/or selected ambience mode. For example, the driving mode or the ambience mode can characterize respective settings of several vehicle components of the motor vehicle. The method thus enables a particularly large number of settings of the respective vehicle components of the motor vehicle to be controlled simultaneously, and thus particularly quickly and easily, via a particularly small number of user inputs, in this case the first user input and the second user input, via a particularly small number of operating elements, in this case the operating device.

In some examples, the first user input representing the selection of the selection level is detected by means of the screen device in response to a swipe on the touch-sensitive surface. This means that a person's contact with the touch-sensitive surface is detected via the touch-sensitive surface and it is also detected whether the touch-sensitive surface is swiped during the contact. When a person's finger moves over the touch-sensitive surface, the swipe and, as a result, the first user input can be detected. The wipe or swipe can, for example, be a swipe gesture. By swiping along the touch-sensitive surface of the screen device, it is thus possible to switch between the respective selection levels available for selection. The swipe gesture representing the swipe enables a person to switch between respective selection levels particularly easily.

In some examples, a third user input is received, wherein the operating device is put into a standby mode in which the operating device may detect the first user input and the second user input. For example, it can be envisaged that the operating device be operated in a passive mode before the third user input is received. In this passive mode, the first user input and the second user input cannot be detected, regardless of whether the touch-sensitive surface is touched, or the ring element is rotated about the axis of rotation. In passive mode, the operating device can be operated in an energy-saving manner. As soon as the third user input has been received, the operating device switches from passive mode to standby mode and is thus ready to receive the first user input and/or the second user input. In passive mode, for example, the screen device may output a respective display with a particularly low brightness, which allows the screen device to be operated in a particularly energy-efficient manner and, moreover, the risk of distraction for a person in the motor vehicle, in particular the driver of the motor vehicle, is kept particularly low. In standby mode, the display of the screen device may be output with a higher brightness in comparison to passive mode, whereby the attention of an occupant of the motor vehicle can be drawn to the operating device in standby mode.

In standby mode, the control device may trigger an output of list participants of a chosen selection level by the screen device, in some examples. This means that in standby mode, list participants of a chosen selection level that are available for selection can be displayed by means of the screen device. For example, the list participants of a chosen selection level that are available for selection are not displayed in passive mode. From the output of the available list participants for the chosen selection level, a person can thus recognize particularly easily that standby mode is set in the operating device. Displaying the list participants of the chosen selection level available for selection in standby mode enables a person to recognize particularly quickly and easily from which list participants a list participant can be chosen via the second user input for setting the motor vehicle or which selection level is chosen.

In some examples, when the operating device is in passive mode and it is detected that the person, such as the occupant of the motor vehicle, is approaching the operating device closer than a predefined limit distance, the third user input is detected, and the operating device is switched from passive mode to standby mode. Alternatively, it is envisaged that when the operating device is in passive mode, when contact by the vehicle occupant with the operating device is detected, the third user input is detected, and the operating device is switched from passive mode to standby mode.

In some examples, when the operating device is in passive mode and rotation of the rotary element is detected, the third user input is detected, and the operating device is switched from passive mode to standby mode. The operating device can thus be woken up by the vehicle occupant approaching the operating device or by the vehicle occupant touching the operating device or by turning the ring element, and it can thus be switched from passive mode to standby mode. The detection of the third user input when determining that the vehicle occupant has approached the operating device closer than the predetermined limit distance allows the operating device to be switched from passive mode to standby mode when the vehicle occupant or their hand approaches the operating device. This can ensure that the operating device is in standby mode as soon as the person or the vehicle occupant touches the operating device to execute the first user input and/or the second user input. In order to prevent a person from unintentionally switching the control device from passive mode to standby mode, for example due to a movement of the person in the vicinity of the control device, the control device can be switched off only when it is detected that the control device has been touched or that the ring element has been moved from passive mode to standby mode. The operating device is thus ready to receive the first user input and the second user input as soon as the person or the vehicle occupant touches the operating device or has adjusted the ring element about the axis of rotation. Detecting the third user input when the ring element has been adjusted about the axis of rotation has the advantage that the risk of accidentally switching the operating device from passive mode to standby mode if the person or the vehicle occupant accidentally touches the operating element is kept particularly low.

In some examples, in passive mode, when a first relative movement of the ring element and/or the screen element is detected along the axis of rotation relative to a base element of the operating device, the third user input is detected, and the operating device is switched from passive mode to standby mode. The base element may be configured for attachment to an interior component of the motor vehicle. The base element is thus fixed relative to the interior component of the motor vehicle. In this case, the operating device is configured to enable a relative movement of the ring element and/or the screen device along the axis of rotation relative to the base element. The third user input can thus be characterized by the pressing of the ring element and/or the screen device along the axis of rotation relative to the base element. The fact that in this embodiment the operating device is only switched from passive mode to standby mode when the movement of the ring element and/or the screen device relative to the base element along the axis of rotation has been detected means that the risk of accidental adjustment of the operating device from passive mode to standby mode can be kept particularly low.

In some examples, when the control device detects a second relative movement of the ring element and/or the screen element along the axis of rotation relative to the base element in standby mode, the display device triggers an output of the set driving mode and/or the set ambience mode. The second relative movement, in particular following the first relative movement, can thus represent a confirmation of a selection of a list participant from a chosen selection level made via the first user input and/or the second user input. As a result of determining the confirmation of the selection made via the first user input and/or the second user input, the control device provides the control signal. Consequently, as a result of the determination of the second relative movement of the ring element and/or the screen element along the axis of rotation relative to the base element which characterizes the confirmation of the selection, the setting of the selection and in particular of the selected list participant of the chosen selection level may be triggered by means of the control device. Alternatively, or additionally, when the second relative movement of the ring element and/or the screen element following the first relative movement is detected along the axis of rotation relative to the base element, the control device can be used to reset the operating device from standby mode to passive mode. This means that when the first relative movement is detected, the operating device is switched from passive mode to standby mode, and when the second relative movement following the first relative movement is detected, the operating device is reset from standby mode to passive mode. As a result, it is particularly easy for the screen device to be reset from standby mode to passive mode or for confirmation of the selection made to be detected.

In some examples, through the selected ambience mode, a respective setting of several participants from ambient light color, ambient light source, ambient light intensity, ambient light rhythm, layout of a freely programmable instrument cluster or a head-up display, layout of a display of a human-machine interface, sound profile, sound balance, volume, audio playlist, system sound, transmission sound and thus clutch sound or gearbox sound, road noise cancellation, air conditioning, ventilation direction, seat back angle, seat heating, seat ventilation, massage recommendation, music playback via a vehicle seat, fragrance, and oxygen content is specified. In the layout of the freely programmable instrument cluster, the layout of the head-up display, and the layout of the human-machine interface, icons, an information density, a font, and special content and transitions of light signals can be set or adjusted depending on the ambience mode selected. In other words, a respective setting of the plurality of participants is predetermined by the respective ambience mode. When selecting one of several predetermined ambience modes, the settings associated with this selected ambience mode are set in the respective designated participants. By selecting a particular ambience mode from the plurality of predetermined ambience modes, it is thus particularly easily for a person to trigger the setting of the respective settings predetermined for this selected ambience mode for the plurality of participants. These participants are, in particular, respective vehicle components of the motor vehicle which serve to improve the comfort of occupants of the motor vehicle. Participants other than the participants mentioned by way of example, and thus further comfort functions provided by vehicle components, are also conceivable.

In some examples, the selected driving mode may determine a respective setting of a plurality of participants, each of which is configured to provide driving functions including adaptive chassis control, steering behavior, engine, adaptive cruise control, and dynamic bending light. The adaptive chassis control can also be referred to as Dynamic Chassis Control (DCC). The adaptive cruise control can also be referred to as a distance control device and Adaptive Cruise Control (ACC). A driving behavior to be set for the motor vehicle can thus be specified via the respective selection of the driving mode. The bundling of the respective settings of the plurality of participants in the respective driving modes enables a person to particularly easily set the driving behavior of the motor vehicle via the operating device. In this case, the person can use the operating device to select, for example, a sporty driving mode or a comfortable driving mode or a particularly economical driving mode. In the respective predefined driving modes, respective settings are predefined for the plurality of participants combined in the driving modes. The adjustment of the settings of the plurality of participants assigned to the selected driving mode is triggered by selecting the respective driving mode. Thus, the setting of the bundled plurality of participants via the selection of the driving mode for the person enables the driving mode of the motor vehicle to be set particularly easily via a particularly small number of user inputs. Participants other than the participants mentioned by way of example, and thus further driving functions provided by vehicle components, are also conceivable.

Turning to the figures, each of the figures shows an operating device 10 in perspective, which is configured for attachment to an interior component of a motor vehicle, in particular a car. This operating device 10 is configured to receive respective user inputs from a person 12, in particular a vehicle occupant, with the motor vehicle being controllable as a function of these user inputs. The operating device 10 is configured to enable a particularly large number of settings by participants and thus vehicle components of the motor vehicle as a function of a particularly small number of user inputs.

In the present examples, the operating device 10 includes a screen device 16 providing a display 14. The screen device 16 has a touch-sensitive surface 18, by means of which contact with the person 12 can be detected. The surface 18 is thus designed to be touch-sensitive and configured to provide an electrical signal upon contact with the person 12. The touching of the touch-sensitive surface 18 by the person 12 can be detected through the electrical signal. In the present case, the screen device 16 is circular. The display 14 extends over an entire area of the screen device 16, forming an outer surface of operating device 10. The display 14 provided by the screen device 16 is also circular. In the present case, the touch-sensitive surface 18 of the screen device 16 extends over the entire display 14.

The operating device 10 also includes a base element 20 and a ring element 22. The ring element 22 can be rotated about an axis of rotation relative to the base element 20. In the present case, this axis of rotation of the ring element 22 coincides with a central axis of the display 14 or the screen device 16. The ring element 22 is arranged circumferentially and thus radially enclosing the screen device 16. In particular, the ring element 22 can be arranged in several mutually different rotation positions about the axis of rotation relative to the base element 20. The base element 20 is configured for attachment to the interior component of the motor vehicle. The operating device 10 can thus be held on the interior component by means of the base element 20. In the present case, the screen device 16 is fixed in its orientation about the axis of rotation of the ring element 22 relative to the base element 20. The screen device 16 therefore does not rotate about the axis of rotation relative to the base element 20. The operating device 10 also includes a control device 24, which is shown schematically in the present case with a box. The control device 24 is configured to provide a control signal, in particular for an electronic computing device (not shown in the figures) of the motor vehicle. The control signal can characterize a setting to be made of at least one vehicle component of the motor vehicle. In order to determine the settings of the vehicle components of the motor vehicle that are to be triggered via the control signal, the operating device 10 is configured to receive respective user inputs from the person 12.

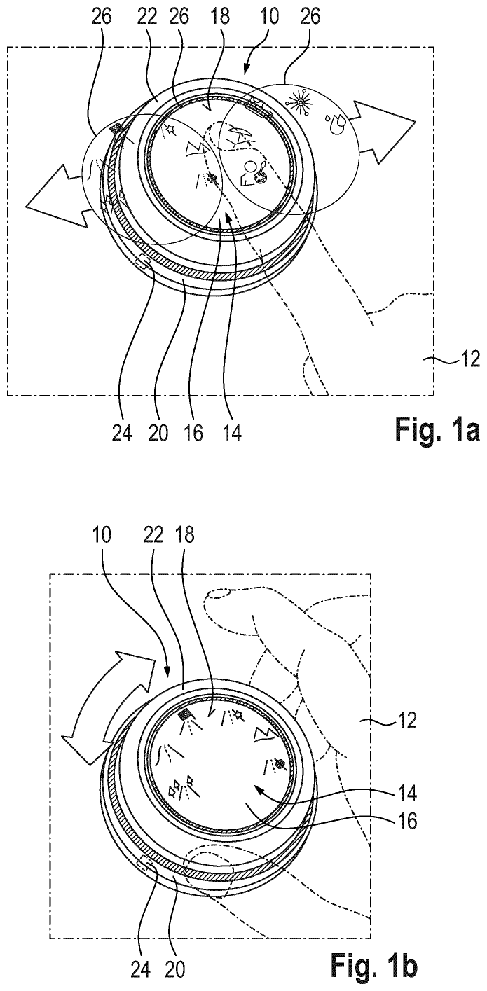

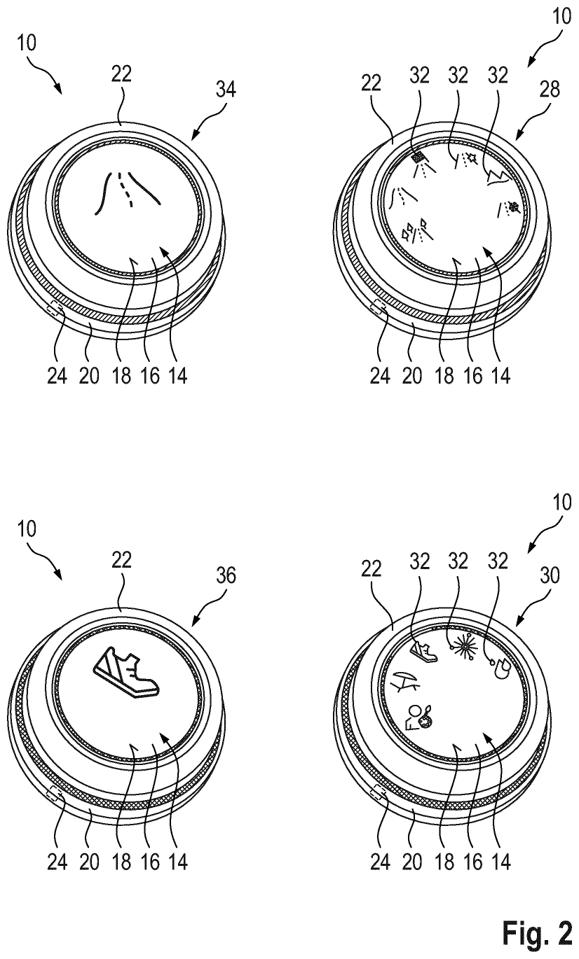

FIG. 1a shows the person 12 swiping a finger across the touch-sensitive surface 18, whereby this swiping across the touch-sensitive surface 18 results in a first user input being made on the control device 10. This first user input is thus represented by touching the touch-sensitive surface 18, in particular by swiping over the touch-sensitive surface 18. By swiping or wiping over the touch-sensitive surface 18, the person 12 can choose one of the selection levels 26 from a plurality of predefined selection levels 26. FIG. 2 shows two different selection levels 26 by way of example. A first selection level 28 provides different adjustable driving modes as list participants 32. A second selection level 30 that differs from the first selection level 28 provides different adjustable ambience modes for selection as list participants 32. In particular, by means of the screen device 16, the list participants 32 of the chosen selection level 26 can be output via the display 14 for selection.

FIG. 1b shows a second user input characterized by rotating the ring element 22 about the axis of rotation. A list participant 32 can be selected from the plurality of list participants 32 of the chosen selection level 26 via this second user input. In particular, a driving mode to be set or an ambience mode to be set can be selected as a list participant 32 by rotating the ring element 22 about the axis of rotation. A respective currently selected list participant 32 of the chosen selection level 26 can be visually highlighted by means of the display 14, as a result of which it is particularly easy for the person 12 to recognize which list participant 32 is currently selected.

As shown in FIG. 2, the set driving mode 34 or the set ambience mode 36 can be displayed by means of the display 14. Alternatively, respective list participants 32 available for selection in a chosen selection level 26 can be displayed by means of the display 14.

The respective settings of respective vehicle components of the motor vehicle, which in particular provide respective comfort functions for vehicle occupants, can be predefined via respective predefined ambience modes of the motor vehicle which can be set by means of the operating device 10. A predefined ambience mode can thus be assigned respective predefined settings of several participants from ambient light color, ambient light source, ambient light intensity, ambient light rhythm, layout of a freely programmable instrument cluster or a head-up display, layout of a display of a human-machine interface, sound profile, sound balance, volume, audio playlist, system sound, transmission sound, road noise cancellations, air conditioning, ventilation direction, seat back angle, seat heating, seat ventilation, massage recommendations, audio playback for a vehicle seat, fragrance, or oxygen content. By selecting one of the predefined ambience modes, the settings of the respective participants in the ambience mode and thus of the vehicle components to be set, which are preset by the ambience mode, can thus be preset collectively. As a result, a particularly large number of settings for the respective vehicle components of the motor vehicle can be specified through a particularly small number of user inputs.

In the respective predefined driving modes, respective settings of vehicle components that influence the driving behavior of the motor vehicle can be predefined. In this case, the respectively selected driving mode can be used to predefine the respective preset settings of a plurality of participants from adaptive chassis control, steering behavior, engine, adaptive cruise control, and dynamic bending light. Thus, by selecting a driving mode from the plurality of driving modes, the person 12 can trigger the respective settings, which are predetermined by the selected driving mode, of the vehicle components configured as participants in this selected driving mode.

In some examples, when operating the operating device 10, the control device 24 may receive the first user input via the screen device 16 and/or the second user input received via the ring element 22. Furthermore, by means of the control device 24, depending on the received first user input and/or the received second user input, the control signal for the computing device of the motor vehicle can be provided, which characterizes the driving mode to be set and/or the ambience mode of the motor vehicle to be set. This means that the setting of the selected driving mode or the selected ambience mode in the motor vehicle is triggered by the provision of the control signal by the control device 24. Furthermore, the control device 24 can be used to control the screen device 16 in such a way that the screen device 16 displays the set driving mode 34 and/or the set ambience mode 36 and/or the respective list participants 32 of the chosen selection level 26.

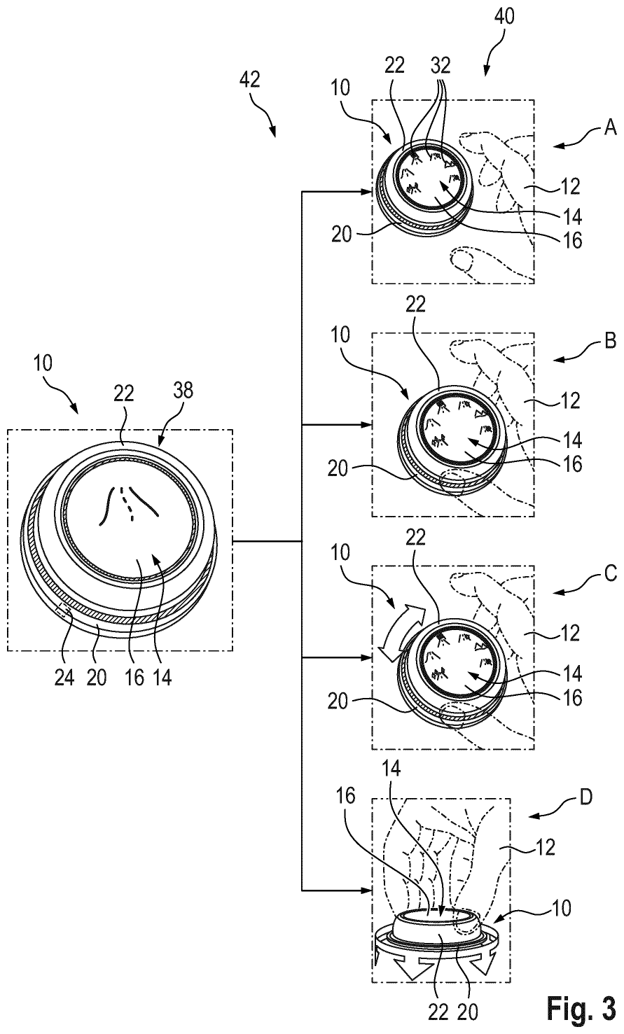

FIG. 3 shows an example of how the operating device 10 can be switched from a passive mode 38 to a standby mode 40. It can be envisaged that in passive mode 38 the first user input and the second user input are not detected by the operating device 10, even when the touch-sensitive surface 18 is touched by the person 12 and also when the ring element 22 is rotated about the axis of rotation. In standby mode 40, the operating device 10 is configured to receive the first user input and the second user input. In particular, it is envisaged that the operating device 10 is switched from passive mode 38 to standby mode 40 by means of the control device 24 when a third user input 42 has been detected on the operating device 10. FIG. 3 shows mutually alternative third user inputs 42. In particular, in the control device 24 it can be envisaged that the operating device 10 is to be switched from passive mode 38 to standby mode 40 only when one of the specified alternative third user inputs 42 is received.

The control device 24 can be configured to trigger the display of the list participants 32 of a chosen selection level 26 by means of the display device 16 as soon as the third user input 42 has been detected. This means that in passive mode 38, the set driving mode 34 and/or the set ambience mode 36 is output by means of the display 14 of the screen device 16. In standby mode 40, the list participants 32 of the chosen selection level 26 are shown by means of the display 14, whereby the person 12 is able to select one of the list participants 32 from the plurality of list participants 32 assigned to the chosen selection level 26.

The control device 24 can determine the third user input 42 if it has been detected that the person 12 has approached the operating device 10 closer than a predetermined limit distance, as is shown in Section A. For this purpose, the operating device 10 can have a proximity sensor, by means of which the approach of the person 12 closer than the predefined limit distance can be detected. Alternatively, the third user input 42 can be determined by means of the control device 24 if contact between the person 12 and the operating device 10 is detected, as illustrated in Section B. Furthermore, as an alternative, the third user input 42 can be determined by means of the control device 24 if, as shown in Section C, a rotation of the ring element 22 about the axis of rotation is detected, in particular if it is detected that the person 12 is in contact with the operating device 10, in particular with the ring element 22, and the ring element 22 is rotated about the axis of rotation. Furthermore, as an alternative, the third user input 42 can be determined by means of the control device 24 if, as shown in Section D, it is detected that the person 12 is pressing the operating device 10. In this case, the third user input 42 is determined when a first relative movement of the ring element 22 and/or the screen device 16 along the axis of rotation relative to the base element 20 is detected in passive mode 38. In this case, the third user input 42 can be determined in particular when the contact between the person 12 and the operating device 10 and also the first relative movement of the ring element 22 and/or the screen device 16 along the axis of rotation relative to the base element 20 are detected.

If a second relative movement of the ring element 22 and/or the screen device 16 along the axis of rotation relative to the base element 20 is detected when the operating device 10 is in standby mode 40, then a confirmation of a selection of a list participant 32 can be determined. As a result of the detection of the confirmation of the selection of the list participant 32, a function of the motor vehicle represented by the selected list participant 32 can be triggered, in particular the driving mode or ambience mode characterized by the list participant 32 can be set in the motor vehicle. In particular, the provision of the control signal can be triggered as a result of the determination of the confirmation when the second relative movement is determined. When the second relative movement of the ring element 22 and/or the screen device 16 along the axis of rotation relative to the base element 20 is detected, the display of the set driving mode and/or the set ambience mode on the screen device 16 can be triggered by means of the control device 24. Alternatively, or additionally, when the second relative movement of the ring element 22 and/or the screen device 16 along the axis of rotation relative to the base element 20 is detected, the operating device 10 can be reset from standby mode 40 to passive mode 38 by means of the control device 24.

Thus, by pressing the ring element 22 and/or the screen device 16 relative to the base element 20 in passive mode 38, the call-up of a dialog and thus the display of the list participants 32 of the chosen selection level 26 available for selection can be triggered as a result of the operating device 10 being switched from passive mode 38 into standby mode 40. A list participant 32 within a chosen selection level 26 can be selected by rotating the ring element 22 about the axis of rotation. The chosen selection level 26 can be changed by swiping along the touch-sensitive surface 18. As a result of the determination of the second relative movement, the dialog can be closed, which is to be understood as meaning that the operating device 10 is switched back from standby mode 40 to passive mode 38. As a result of the operating device 10 being switched back from standby mode 40 to passive mode 38, a display 14 characterizing the selected list participant 32 is provided by the screen device 16.

In passive mode 38, an animation characterizing the selected list participant 32 can be provided by means of the display 14. In standby mode 40, the display 14 can provide interaction-enhancing animations.

When the screen device 16 is switched on, the last piece of information provided in a previously active state of the screen device 16 can be displayed by means of the display 14. When the screen device 16 is deactivated, the display 14 can be hidden.

Overall, the invention shows how a particularly advantageous operating concept for a driving experience switch can be provided in the form of an operating device 10.

### LIST OF REFERENCE SYMBOLS

10 Operating device
12 Person
14 Display
16 Screen device
18 Touch-sensitive surface
20 Base element
22 Ring element
24 Control device
26 Selection level
28 Driving modes
30 Ambience modes
32 List participants
34 Driving mode
36 Ambience mode
38 Passive mode
40 Standby mode
42 Third user input

1-10. (canceled)

11. A method for operating an operating device for a motor vehicle, comprising:
receiving a first user input via a touch-sensitive surface of a screen device, the first user input characterizing a selection of a selection level from a plurality of selection levels, wherein a first selection level comprises different adjustable driving modes as list participants and a second selection level comprises different adjustable ambience modes as list participants;
receiving a second user input via a rotating a ring element, configured circumferentially enclosing the screen device about an axis of rotation, the first user input characterizing a selection of a list participant from a plurality of list participants associated with the selected selection level of the first user input; and
providing a control signal via a control device, depending on the first user input and/or the second user input, the control signal characterizing a driving mode to be set and/or an ambience mode of the motor vehicle to be set; and
setting a driving mode and/or an ambience mode for the vehicle triggered by control signal.

12. The method according to claim 11, wherein, the first user input representing the selection of the selection level is detected via the screen device as a function of a swipe over the touch-sensitive surface.

13. The method according to claim 11, further comprising receiving a third user input, causing the operating device to be placed in a standby mode, in which the operating device can detect the first user input and the second user input.

14. The method according to claim 13, wherein the standby mode causes the control device to trigger an output of list participants of a chosen selection level by the screen device.

15. The method according to claim 13, further comprising one of:
detecting an approach of a vehicle occupant closer than a predetermined limit distance to the operating device,
detecting a contact of the vehicle occupant with the operating device, or
detecting a rotation of the ring element,
when the operating device is in a passive mode, wherein the third user input is determined and the operating device is switched from the passive mode to the standby mode.

16. The method according to claim 13, further comprising detecting a first relative movement of the ring element and/or the screen device along the axis of rotation relative to a base element of the operating device when the operating device is in a passive mode; and determining the third user input to switch the operating device from the passive mode to the standby mode.

17. The method according to claim 16, further comprising:
detecting, in the standby mode, a second relative movement of the ring element and/or the screen device along the axis of rotation relative to the base element; and
triggering an output of the set driving mode and/or the set ambience mode by the screen device

18. The method according to claim 11, wherein the selected ambience mode predetermines a respective setting of a plurality of participants from one or more of
an ambient light color
an ambient light source
an ambient light intensity
an ambient light rhythm
a layout of a freely programmable instrument cluster or a head-up display
a layout of a display of a human-machine interface
a sound profile
a sound balance
a volume
an audio playlist
a system sound
a transmission sound
a road noise cancellation
air conditioning
ventilation direction
a seat back angle
seat heating
seat ventilation
a massage recommendation
audio playback for a vehicle seat
a fragrance
an oxygen content.

19. The method according to claim 11, wherein the selected driving mode predetermines a respective setting of a plurality of participants from one or more of
an adaptive chassis control
a steering behavior
an engine
an adaptive cruise control
a dynamic bending light.

20. A motor vehicle, comprising:
an operating device;
a screen device comprising a touch-sensitive surface for
receiving a first user input, the first user input characterizing a selection of a selection level from a plurality of selection levels, wherein a first selection level comprises different adjustable driving modes as list participants and a second selection level comprises different adjustable ambience modes as list participants, and
receiving a second user input via a rotating a ring element, configured circumferentially enclosing the screen device about an axis of rotation, the first user input characterizing a selection of a list participant from a plurality of list participants associated with the selected selection level of the first user input; and
a control device, operatively coupled to the screen device for providing a control signal depending on the first user input and/or the second user input, the control signal characterizing a driving mode to be set and/or an ambience mode of the motor vehicle to be set and setting a driving mode and/or an ambience mode for the vehicle triggered by control signal.

21. The motor vehicle according to claim 20, wherein, the first user input representing the selection of the selection level is detected via the screen device as a function of a swipe over the touch-sensitive surface.

22. The motor vehicle according to claim 20, wherein the screen device is configured to receive a third user input, causing the operating device to be placed in a standby mode, in which the operating device can detect the first user input and the second user input.

23. The motor vehicle according to claim 22, wherein the standby mode causes the control device to trigger an output of list participants of a chosen selection level by the screen device.

24. The motor vehicle according to claim 22, wherein the operating device is configured to:
detect an approach of a vehicle occupant closer than a predetermined limit distance to the operating device,
detect a contact of the vehicle occupant with the operating device, or
detect a rotation of the ring element,
when the operating device is in a passive mode, wherein the third user input is determined and the operating device is switched from the passive mode to the standby mode.

25. The motor vehicle according to claim 22, wherein the operating device is configured to
detect a first relative movement of the ring element and/or the screen device along the axis of rotation relative to a base element of the operating device when the operating device is in a passive mode; and
determine the third user input to switch the operating device from the passive mode to the standby mode.

26. The motor vehicle according to claim 25, wherein the operating device is configured to:
detect, in the standby mode, a second relative movement of the ring element and/or the screen device along the axis of rotation relative to the base element; and
trigger an output of the set driving mode and/or the set ambience mode by the screen device

27. The motor vehicle according to claim 20, wherein the selected ambience mode predetermines a respective setting of a plurality of participants from one or more of
an ambient light color
an ambient light source
an ambient light intensity
an ambient light rhythm
a layout of a freely programmable instrument cluster or a head-up display
a layout of a display of a human-machine interface
a sound profile
a sound balance
a volume
an audio playlist
a system sound
a transmission sound
a road noise cancellation
air conditioning
ventilation direction
a seat back angle
seat heating
seat ventilation
a massage recommendation
audio playback for a vehicle seat
a fragrance
an oxygen content.

28. The motor vehicle according to claim 20, wherein the selected driving mode predetermines a respective setting of a plurality of participants from one or more of
an adaptive chassis control
a steering behavior
an engine
an adaptive cruise control
a dynamic bending light.

29. A method for operating an operating device for a motor vehicle, comprising:
receiving a swiped first user input via a touch-sensitive surface of a screen device, the first user input characterizing a selection of a selection level from a plurality of selection levels, wherein a first selection level comprises different adjustable driving modes as list participants and a second selection level comprises different adjustable ambience modes as list participants;
receiving a second user input via a rotating a ring element, configured circumferentially enclosing the screen device about an axis of rotation, the first user input characterizing a selection of a list participant from a plurality of list participants associated with the selected selection level of the first user input; and
providing a control signal via a control device, depending on the first user input and/or the second user input, the control signal characterizing a driving mode to be set and/or an ambience mode of the motor vehicle to be set; and
setting a driving mode and/or an ambience mode for the vehicle triggered by control signal.

30. The method according to claim 29, further comprising receiving a third user input, causing the operating device to be placed in a standby mode, in which the operating device can detect the first user input and the second user input, wherein the standby mode causes the control device to trigger an output of list participants of a chosen selection level by the screen device.
